(19) United States
(12) Patent Application Publication
(10) Pub. No.: US 2025/0381640 A1
(43) Pub. Date: Dec. 18, 2025

(54) ABRASIVE-FREE PLANARIZATION OF POLYCRYSTALLINE SILICON

(71) Applicant: CHEMPOWER CORPORATION, Beaverton, OR (US)

(72) Inventors: Sudhanshu Misra, Camas, WA (US); Suryadevara Babu, Portland, OR (US); Nikunjkumar R. Visaveliya, Lyndhurst, NJ (US)

(21) Appl. No.: 19/240,555

(22) Filed: Jun. 17, 2025

Related U.S. Application Data
(60) Provisional application No. 63/660,956, filed on Jun. 17, 2024.

(51) Int. Cl. B24B 37/24; C09G 1/16

(52) U.S. Cl. CPC B24B 37/24; C09G 1/16

(57) ABSTRACT

A pad for performing abrasive-free chemical planarization of a polycrystalline silicon (polysilicon) surface, the pad comprising a polymer layer incorporating a functional group reactive with polysilicon to remove silicon from the polysilicon surface.

### CROSS REFERENCE TO RELATED APPLICATIONS

This application claims priority to U.S. Provisional Application 63/660,956, entitled “PADS FOR ABRASIVE-FREE POLISHING OF POLY-SI FILMS” and filed Jun. 17, 2024, the entirety of which is hereby incorporated herein by reference for all purposes.

### BACKGROUND

Chemical mechanical planarization (CMP) is commonly used in integrated circuit fabrication processes to smooth surfaces, such as that of a semiconductor substrate, by removal of material using a combination of chemical and mechanical forces. A typical CMP process involves using an abrasive and a chemical slurry that can be corrosive to the material being removed, in combination with a planarization pad. The substrate and planarization pad are pressed together, and rotated relative to one another with non-concentric axes of rotation. The combination of the force and slurry removes areas of the substrate with a higher topology compared to areas with a lower topology, thereby smoothing the surface.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to pads for performing abrasive-free chemical planarization of polycrystalline silicon. One example provides A pad for performing abrasive-free chemical planarization of a polycrystalline silicon (polysilicon) surface, the pad comprising a polymer layer incorporating a functional group reactive with polysilicon to remove silicon from the polysilicon surface.

### BRIEF DESCRIPTION OF THE FIGURES

FIG. 1 schematically illustrates an example of polysilicon planarization using a functionalized planarization pad.

FIG. 2 shows an example quaternary ammonium group.

FIG. 3 shows an example process for dispersing small functional molecules into a polymer network of a planarization pad.

FIG. 4 shows example small molecules that can be dispersed in a planarization pad.

FIG. 5 shows an example process for dispersing a polyelectrolyte into a polymer network of a polymer planarization pad.

FIG. 6 shows example polyelectrolytes that can be dispersed in a planarization pad.

FIG. 7 shows an example process for covalently bonding small functional molecules to a polymer network of a planarization pad.

FIG. 8 schematically shows polymerization reactions for producing polyurea, polyurethane, and a polyurea-polyurethane copolymer.

FIG. 9 shows an example process for covalently bonding small functional molecules into a polyurea-polyurethane copolymer network of a polymer planarization pad.

FIG. 10 shows an example functional molecule comprising a —N═ functional group that can be covalently bonded into a polyurea-polyurethane copolymer network or other polymer network of a planarization pad.

FIG. 11 shows an example process for covalently bonding a functional molecule comprising a quaternary ammonium group into a planarization pad.

FIG. 12 shows an example molecule comprising a quaternary ammonium group.

FIG. 13 shows an example incorporation of a polyelectrolyte into a polymer network of a polymer pad by covalent bonding.

FIG. 14 shows a block diagram of an example chemical planarization system.

FIG. 15A shows a schematic depiction of an example pad for performing chemical planarization.

FIG. 15B shows the example pad of FIG. 15A and illustrates contact between topologically higher portions of a substrate and an upper layer of the pad.

FIG. 16 shows a schematic depiction of another example pad for performing chemical planarization.

FIG. 17 shows a schematic depiction of another example pad comprising a textured substrate-facing surface.

FIG. 18 shows a graph of polysilicon removal rate as a function of poly(diallydimethylammonium chloride) (PDADMAC) concentration in a planarization solution when using an example carboxylic-functionalized pad according to the present disclosure.

FIG. 19 shows a graph of polysilicon removal rate as a function of pH of a planarization solution when using an example carboxylic-functionalized pad according to the present disclosure with a PDADMAC planarization solution.

FIG. 20 shows a graph of polysilicon removal rate as a function of a pH adjuster in a planarization solution when using an example carboxylic-functionalized pad according to the present disclosure with a PDADMAC planarization solution.

FIG. 21 shows a graph of polysilicon removal rate as a function of pad pressure against a polysilicon surface when using an example carboxylic-functionalized pad according to the present disclosure with a PDADMAC planarization solution.

FIG. 22 shows a graph of polysilicon removal rate as a function of planarization solution flow rate when using an example carboxylic-functionalized pad according to the present disclosure with a PDADMAC planarization solution.

FIG. 23 shows example molecules for functionalizing a polymer planarization pad and/or for including in a planarization solution when using a functionalized pad according to the present disclosure.

### DETAILED DESCRIPTION

Some semiconductor device fabrication processes require polycrystalline silicon (polysilicon) films to be planarized. Along with achieving nanolevel planarity, there is a compelling and continuing need to eliminate defects during the planarization of these polysilicon films to help ensure high yields. However, as mentioned above, current chemical mechanical planarization (CMP) processes utilize abrasives and chemical slurries to perform planarization. Such abrasives can lead to defect formation.

One possible approach to reduce defects formed during planarization is to utilize abrasive-free reactive aqueous solutions for planarization. Reactive or functionalized planarization pad structures that eliminate the need for abrasive particles during planarization, when properly designed, can help to avoid defect creation. Further, abrasive-free planarization of thin films also can help to avoid particle-related defects, post-planarization particle removal from the surfaces of films, and the need to dispose of particles in post-polish polishing slurries. Such benefits are described, for example, in U.S. Pat. No. 9,097,994, titled ABRASIVE-FREE PLANARIZATION FOR EUV MASK SUBSTRATES and issued Aug. 4, 2015; and U.S. Pat. No. 11,545,365, titled CHEMICAL PLANARIZATION and issued (Jan. 3, 2023), the contents of which are hereby incorporated by reference.

The functionalized reactive pads disclosed in U.S. Pat. No. 9,097,994 are configured for planarizing metallic films, such as copper films. However, such pads may not be suitable for planarizing polysilicon films. Some methods of polysilicon planarization can be performed using aqueous solutions of one or more of poly(diallyldimethylammonium chloride) (PDADMAC), poly(dimethylamine-co-epichlorohydrin-co-ethylenediamine), poly(allylamine), or poly(ethylene imine). Maintaining the solution pH in the alkaline region can facilitate planarization of polysilicon with such planarization solutions. Such polysilicon planarization solutions can provide suitable planarization rates when used with conventional polyurethane-based CMP pads in the selective polishing of polysilicon over silicon dioxide and silicon nitride films. Examples of such pads include IC-1000 pads and other IC series pads available from DuPont Electronic Materials CMP, LLC of Newark, DE, as well as with the functionalized pads disclosed in the above-referenced U.S. Pat. No. 11,545,365.

However, aqueous polysilicon planarization solutions that utilize poly(diallyldimethylammonium chloride) (PDADMAC), poly(dimethylamine-co-epichlorohydrin-co-ethylenediamine), poly(allylamine), and/or poly(ethylene imine) may not provide suitably high planarization rates when used with other pad structures, such as POLITEX pads, also available from DuPont Electronic Materials CMP, LLC. POLITEX pads are made from microporous urethane having a surface morphology derived from the ends of columnar void structures in bulk urethane and are grown on a urethane felt base. In contrast, IC-series pads are filled and/or blown composite urethanes having surface structures made up of hemispherical depressions derived from exposed hollow spherical elements or incorporated gas bubbles. The concentration of urethane groups in an IC-1000 pad is about 7.7% while it is much lower at 3.3% in a POLITEX pad. Furthermore, in the example of using a PDADMAC planarization solution, when coupled with the higher surface concentrations of the hydrolysable groups in an IC-1000, the anion density and the extent and the strength of PDADMAC adsorption are higher for IC-1000 pads than POLITEX pads. This leads to the observable differences in the planarization rates of these two type of pads. Similar behavior can be anticipated while using the aqueous solutions of poly(dimethylamine-co-epichlorohydrin-co-ethylenediamine), poly(allylamine), and poly(ethylene imine). However, current abrasive-free planarization pads lack functional groups built into the planarization pad that can remove polysilicon efficiently during planarization.

Accordingly, examples are disclosed that relate to building the reactive functionalities of such polysilicon planarization molecules as poly(dimethylamine-co-epichlorohydrin-co-ethylenediamine), poly(allylamine), and poly(ethylene imine) into a polyurethane backbone network of an abrasive-free planarization pad. By building these reactive functionalities into the polyurethane backbone network, higher planarization rates may be achieved compared to planarization pads lacking the built-in reactive functionalities. Further, this may allow concentrations of such planarization molecules to be reduced in a planarization solution, or entirely omitted, thereby saving costs and reducing waste.

Some examples utilize amine-based or quaternary ammonium salt-based compounds for planarizing polysilicon. Amine-based as well as quaternary ammonium salt-based compounds are promising for polysilicon removal rates during CMP process. Incorporating them into a polyurethane planarization pad not only may provide for beneficial polysilicon removal rates, but also may allow the planarization of multiple wafers without utilizing such compounds in solution, thereby potentially reducing expense and an amount of waste generated.

Polyurethane/polyurea pads can employ isocyanate-based prepolymer building blocks during pad formulation. Some amines may be very reactive to isocyanates. Hence, it may be challenging to retain unreacted amine-based functional groups (available for polishing application) during pad formulation. As it is advantageous to keep amine-based functional groups available for polishing after pad formulation, example approaches are described below to retain amine-based functional groups available for polishing after pad formulation.

The mechanism for the amine-based or quaternary ammonium salt-based removal of polysilicon is as follows. Polysilicon contains silicon-silicon bonding throughout. Thus, to remove silicon, silicon-silicon bonds have to be weakened and ruptured during polishing. The use of a planarization solution with a basic pH allows hydroxyl ions (e.g. as provided by a base such as KOH as pH adjuster) can polarize silicon-silicon bonds. Here, hydroxide ions (OH⁻) can coordinate with a silicon atom having a partial positive charge. Likewise, the nitrogen atom of a quaternary ammonium group can coordinate with a silicon atom having a partial negative charge. Thus, the nitrogen atom of the quaternary ammonium group can form a bond with a silicon atom of a polysilicon surface to form a silicon-nitrogen bond. The silicon-silicon bond energy is lower than the silicon-nitrogen bond energy. Hence, the silicon-silicon bond can be ruptured during polishing, and the silicon can be captured by quaternary ammonium group. This results in etching of the polysilicon.

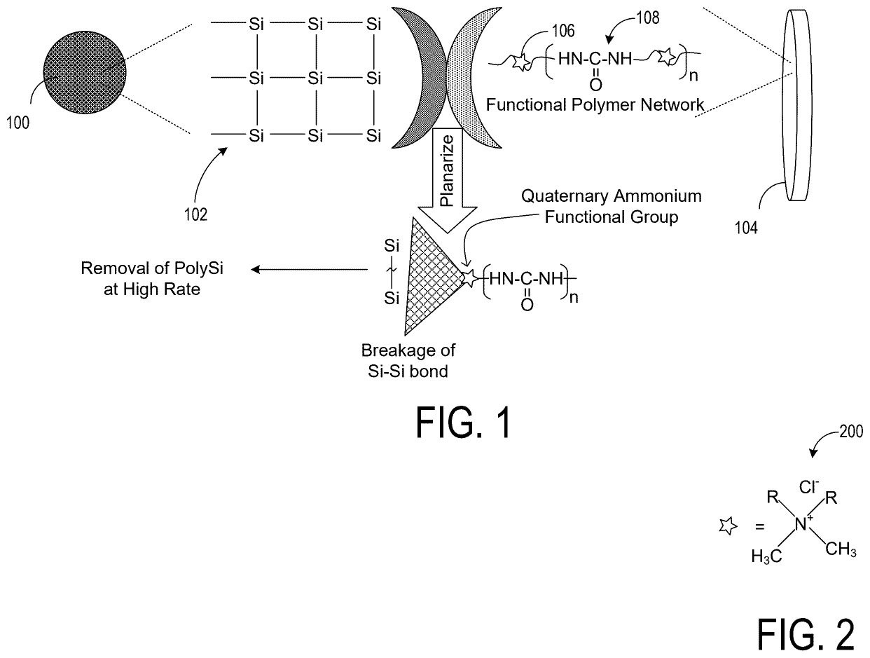

A general mechanistic overview of polysilicon planarization is shown in FIG. 1. More particularly, in FIG. 1, a substrate with a polysilicon surface (here shown as polysilicon wafer 100) includes silicon-silicon bonding, as shown in the magnified view 102. A planarization pad 104 is functionalized with quaternary ammonium functional groups 106 integrated with the backbone of the polymer of the planarization pad 104. The quaternary ammonium functional groups 106 are represented by stars in chemical structure 108, which represents the polymer backbone of planarization pad 104. The quaternary ammonium functional groups 106 polarize and react with the silicon-silicon bonds, thereby breaking the silicon-silicon bonds and complexing the silicon with the nitrogen atom of the ammonium. This results in etching of the polysilicon wafer 100. FIG. 2 shows an example quaternary ammonium group 200 having two methyl groups, two R— groups (e.g. that can be polymer chains of a planarization pad backbone), and a chloride ion to balance the positive charge of the quaternary ammonium group. In other examples, other quaternary ammonium groups can be used. Further, free amine groups (e.g. —NR₂ groups, where each R is H or other terminal group, including aliphatic and aromatic organic groups, halogen groups, etc.) and —N═ groups also can be used in some examples.

To form a polyurethane-based planarization pad, such as a polyurea-polyurethane copolymer pad, a pre-polymer containing isocyanates and a curative agent comprising amine groups form urea (—HN—CO—NH—) linkages in polymer network. Incorporating free amine and/or quaternary ammonium groups into the polymer network can provide the planarization pad with the planarization capabilities of FIG. 1.

Various methods can be used to incorporate free amine, —N═, and/or quaternary ammonium groups into a polyurethane planarization pad. A first approach is to form a dispersion of functional molecules (small molecules or polymers) within the polymer network of the polyurethane planarization pad, where the small molecules comprise such functional groups. In some such examples, small functional molecules that contains only one functional site per molecule can be dispersed in the polymer network. In other examples, a small functional molecule can have two or more functional sites per molecule. Due to the thermosetting characteristics of a polyurethane planarization pad, functional molecules can be fixed into network with a relatively low chance of leaching. Functional molecules fixed within a polyurethane planarization pad in this manner can form silicon-nitrogen bonding during polishing of polysilicon wafers. Tails of the functional molecules can be adsorbed or fixed to the polymer network, while a head functional group (e.g. quaternary ammonium) is available to chelating or complexing with Si-atoms of polysilicon wafers.

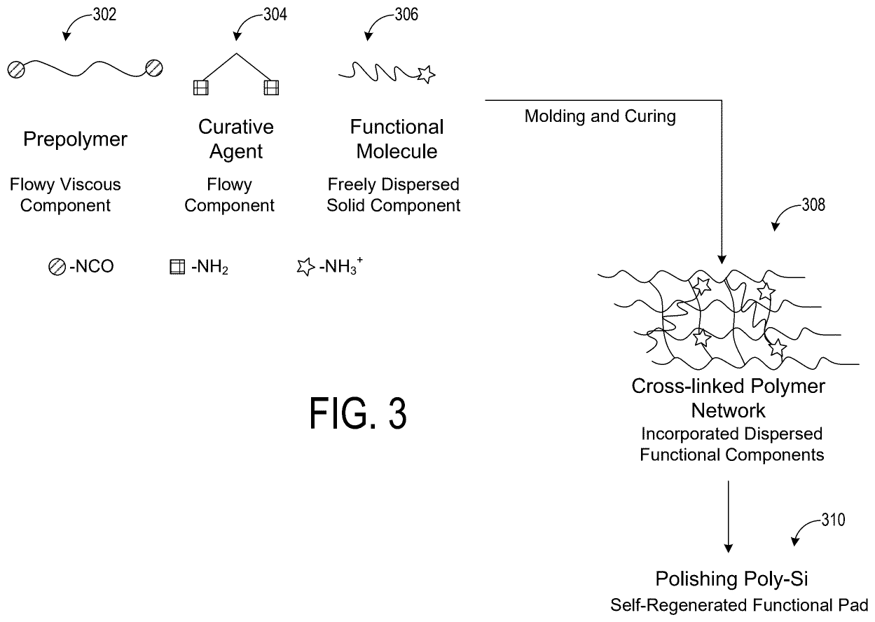

FIG. 3 schematically shows an example process for dispersing small functional molecules comprising free amine groups (e.g. —NH₂ groups) into a polymer planarization pad. First, a prepolymer 302 (e.g. with isocyanate end groups), a curative agent 304 (e.g. with amine or hydroxy end groups), and functional molecules 306 are mixed to form a mixture. Then, the mixture is reacted in a molding and curing process under conditions that cause the prepolymer 302 and the curative agent 304 to react and form a cross-linked polymer network 308. As the functional molecules 306 were dispersed in the mixture with the prepolymer 302 and curative agent 304, the functional molecules become fixed in the polymer network. Some free amine groups of the functional molecules 306 will be exposed to a polysilicon surface during an etching process, and thus can etch the polysilicon surface as described above. The resulting polymer planarization pad can then be used to planarize polysilicon, as shown at 310.

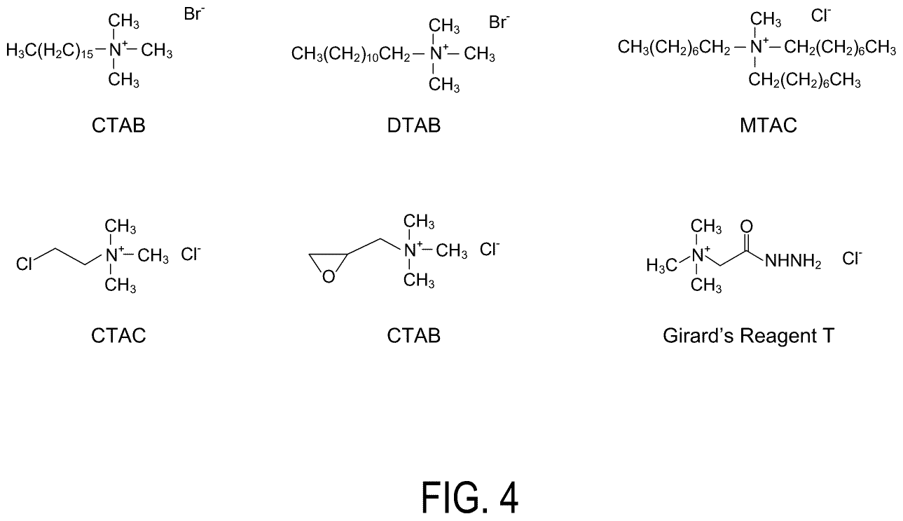

Example small functional molecules that may be useful for planarizing polysilicon wafers are shown in FIG. 4. These example small molecules are methyltrioctylammonium chloride (MTAC), cetyltrimethylammonium Bromide (CTAB), dodecyltrimethylammonium bromide (DTAB), (2-Chloroethyl)trimethylammonium chloride (CTAC), glycidyltrimethylammonium chloride (GTAC), and Girard's Reagent T. These molecules are readily available and provide cost-effective production of functional pads for polysilicon planarization. Also, these molecules may present no significant hazardous effect based on their chemical nature. Hence, utilizing such small functional molecules can help to provide a sustainable as well as environmentally friendly approach. It will be appreciated that the molecules illustrated in FIG. 4 are presented for the purpose of example and are not intended to be limiting in any manner, as other suitable molecules with free amine or quaternary ammonium groups can be incorporated into a polymer planarization pad according to the present examples.

In some examples, a dispersion of functional cationic polyelectrolytes, alternatively or additionally to small molecules, can be formed within the polymer network of the polyurethane planarization pad. A cationic polyelectrolyte is a cationic polymer that contains multiple cationic functional sites per component. Cationic polyelectrolytes are made up of small functional building blocks that are bonded together in a long polymeric chain. An advantage of utilizing polyelectrolytes is the availability of large number of functional sites for its functional application. Further, due to its elongated chain, cationic polyelectrolytes can be fixed more securely in a polymer network than small molecules. This may help to further reduce the chance of functional molecules leaching from polymer network over repeated polishing process. Polyelectrolytes can be dispersed in a similar manner to small molecules during pad formulation process as explained above.

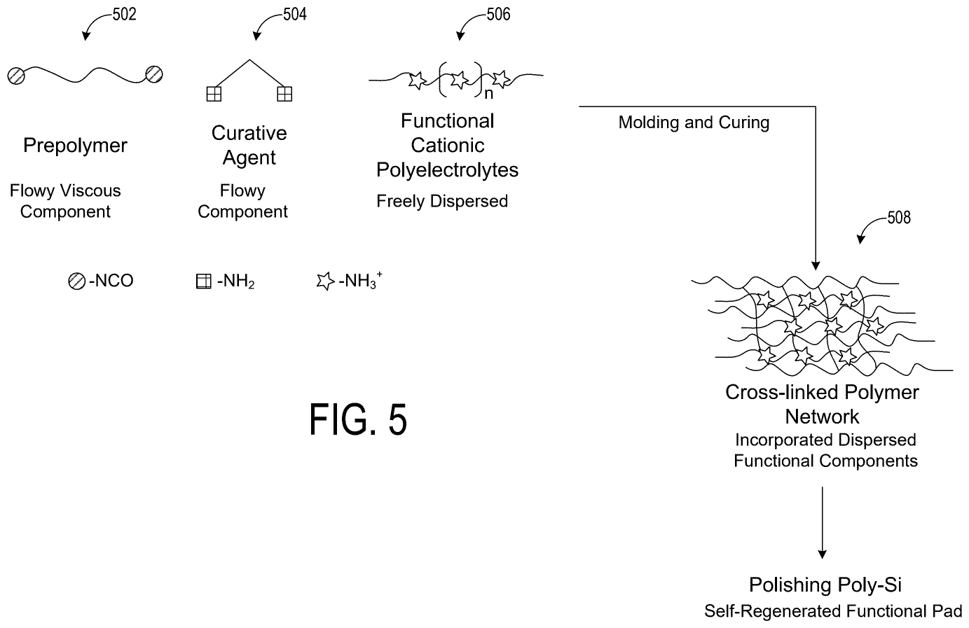

FIG. 5 schematically illustrates a process for dispersing polyelectrolytes comprising quaternary ammonium groups into a polymer planarization pad. First, a prepolymer 502 (e.g. with isocyanate end groups), a curative agent 504 (e.g. with amine or hydroxyl end groups), and functional cationic polyelectrolyte molecules 506 are mixed to form a mixture. Then, the mixture is reacted in a molding and curing process under conditions that cause the prepolymer 502 and the curative agent 504 to react and form a cross-linked polymer network 508. As the functional molecules 506 were dispersed in the mixture with the prepolymer 502 and curative agent 504, the functional molecules become fixed in the polymer network. Some free amine groups of the functional molecules 506 will be exposed to a polysilicon surface during an etching process, and thus can etch the polysilicon surface as described above.

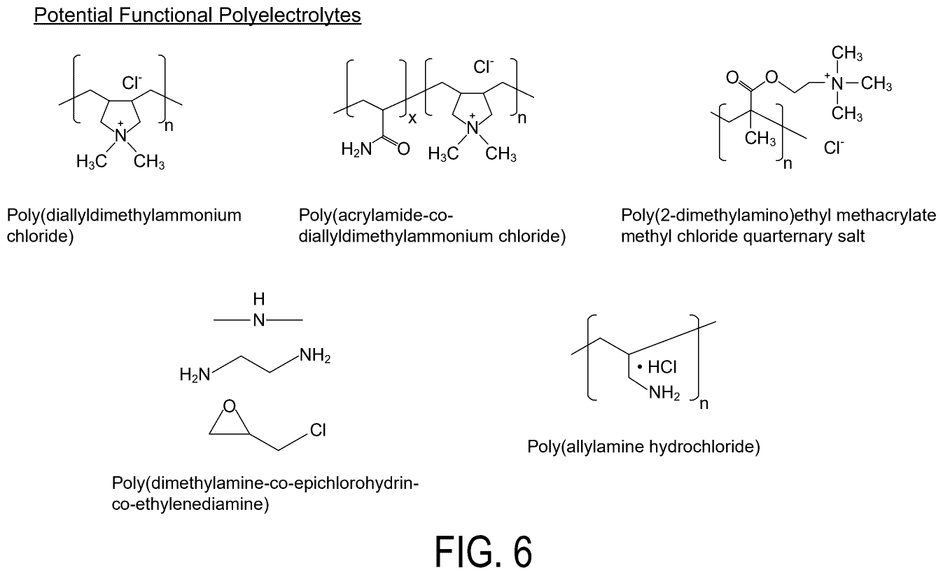

Example polyelectrolytes that may be useful for planarizing polysilicon wafers are shown in FIG. 6. These example polyelectrolytes are poly(diallyldimethylammonium chloride), poly(acrylamide-co-diallyl dimethylammonium chloride, poly(2-dimethylamino)ethyl methacrylate) methyl chloride, poly(dimethylamine-co-epichlorohydrin-co-ethylenediamine), and poly(allylamine hydrochloride). Again, these materials are readily available and provide cost-effective production of functional pads for polysilicon planarization. Also, these molecules may present no significant hazardous effect based on their chemical nature. Hence, utilizing such small functional molecules can help to provide a sustainable as well as environmentally friendly approach. It will be appreciated that the molecules illustrated in FIG. 4 are presented for the purpose of example and are not intended to be limiting in any manner, as other suitable molecules with free amine or quaternary ammonium groups can be incorporated into a polymer planarization pad according to the present examples.

In the approaches above, functional small molecules or functional polyelectrolytes are dispersed into a polymer network of a pad, without being covalently bonded. Another approach to incorporate polysilicon planarization functionality into a polymer planarization pad is to covalently link functional molecules to the polymer of the polymer planarization pad. Various methods can be used to form a covalently linked functional polymeric network useful for polysilicon planarization. As mentioned above, planarization pads can be formed from isocyanate-based polymers (e.g. polyurethane), which react with nucleophilic functional group rapidly at an elevated temperature. Example approaches are presented here for covalently linking reactive-sited small functional molecules and reactive-sited functional cationic polyelectrolytes.

Regarding covalently linking small molecules to polymer planarization pad, reactivity of small molecules can be relatively high in a chain-extending polymerization process due to the relatively high mobility of the small molecules in the solution phase. However, formulation of the pads can require certain gel-time, moldability, hardness, and surface/physical properties such as asperity, porosity, and surface morphology. Thus, chemical and mechanical/physical properties need to be suitably balanced and controlled. Conventional planarization pads only provide mechanical aspects required in chemical mechanical planarization applications. Here, chemical functionality also is being introduced into the pad to reveal chemical aspects dominantly alongside mechanical aspects for planarization. To avoid interfering with desired physical properties of polymer planarization pads, a strategic approach can be employed. In this approach, functional molecules should contain an efficient chelator to chelate and thereby capture silicon removed from a polysilicon surface being planarized, while also ensuring that the resulting polymer planarization pad has desired mechanical and physical properties, including the above-example properties. Examples of suitable chelators can include an N-atom present in aromatic ring (e.g. a —N═ group), a free amine functional group (—NR₂), a quaternary ammonium group (NR₄⁺), etc.

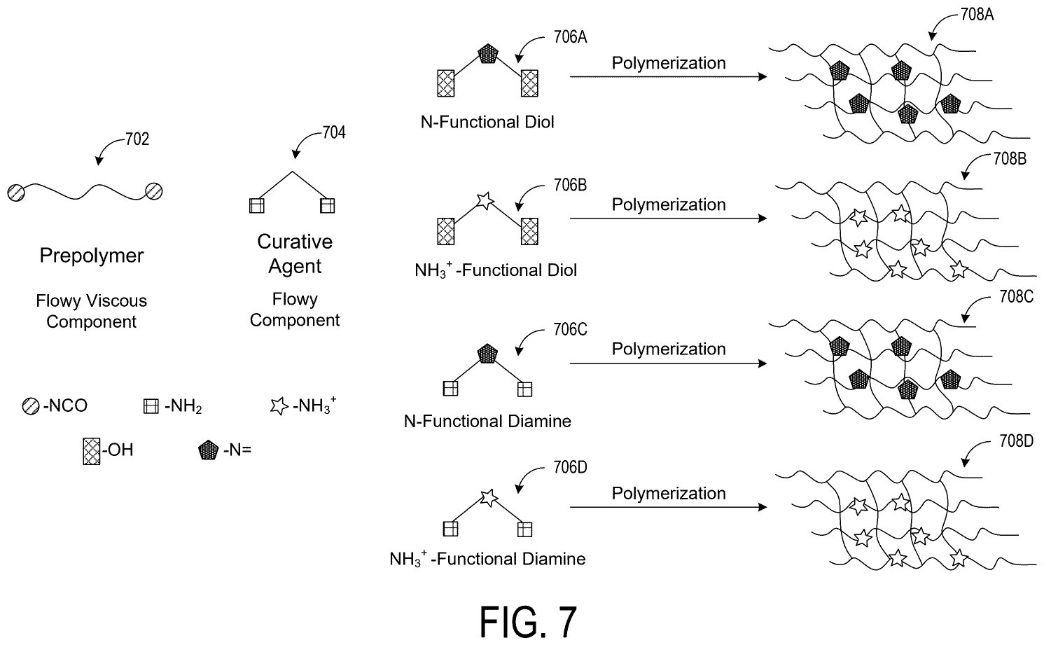

To incorporate such functional group or groups into a polymer planarization pad, the functional group or groups can be first tailored in a diamine or diol compound, as examples of functional groups that can be used to covalently link the functional groups used for polysilicon planarization to a polymer planarization pad. An example is shown in FIG. 7. Here, a prepolymer 702 with isocyanate end groups, a curative agent 704 with amine end groups, and a functional molecule with suitable functional end groups to react with the prepolymer (e.g. amine or hydroxyl end groups) are mixed. Example functional molecules shown in FIG. 7 include a functional diol with an —N═ group 706A, a functional diol with a quaternary ammonium group 706B, a functional diamine with an —N═ group 706C, and a functional diamine with a quaternary ammonium group 706D. In other examples, any other suitable functional groups that can etch polysilicon can be used. After mixing, the mixture is molded and cured as described above. The resulting polymer (e.g. polymers 708A, 708B, 708C, 708D) have at least some of the molecule incorporated into the polymer chains that form the polymer network of the planarization pad, rather than dispersed within a polymer network.

As shown in FIG. 7, one example type of small functional molecules comprise —N═ functional sites to interact with silicon atoms of a polysilicon surface. For instance, 2,6-pyridinedimethanol is an example functional molecule candidate.

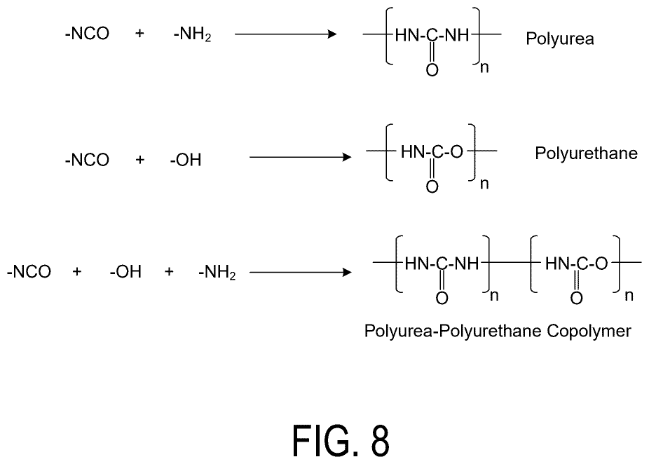

In some examples, a functional molecule can be incorporated into in the polymer network covalently based on polyurea-polyurethane copolymeric cross-linked network. Using a polyurea-polyurethane network in a functional pad may balance chemical functionality and moldability/hardness of the polymeric pads for planarization applications. This is because a greater polyurea content can produce a relatively harder pad, whereas a greater polyurethane content can produce a relatively softer pad. 2,6-pyridinedimethanol is one example of a functional molecule that can be covalently incorporated into a polyurea-polyurethane network of a planarization pad. Reactions that illustrate the formation of polyurea, polyurethane, and a polyurea-polyurethane copolymer are illustrated in FIG. 8.

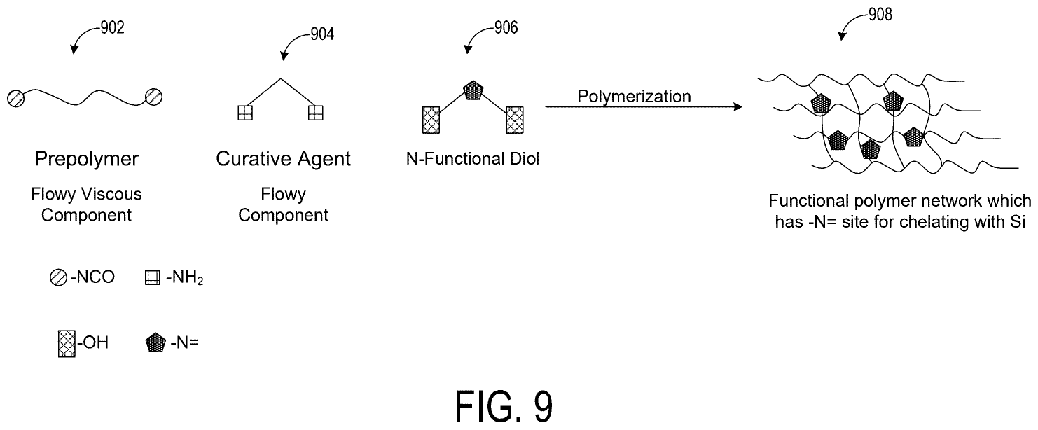

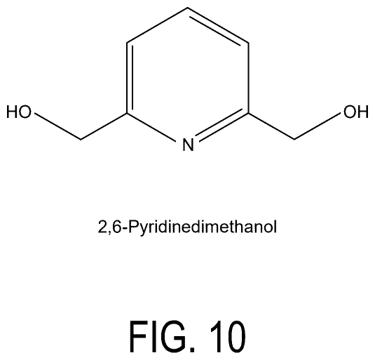

FIG. 9 shows an example incorporation of a functional molecule comprising a —N═ functional molecule (e.g. an imine or a cyclic molecule comprising a —N═ group within a ring) into a polyurea-polyurethane copolymer. In FIG. 9, a prepolymer 902 with isocyanate end groups, a curative agent 904 with amine end groups, and a functional molecule 906 with suitable functional groups (e.g. hydroxyl groups) to react with the prepolymer 902 are mixed. After mixing, the mixture is molded and cured as described above. The resulting polymer 908 has at least some of the molecule incorporated into the polymer chains that form the polymer network of the planarization pad, rather than dispersed within a polymer network. An example functional molecule is 2,6 pyridinemethanol, a structure of which is shown in FIG. 10. In other examples, any other suitable functional molecule comprising a —N═ group can be used.

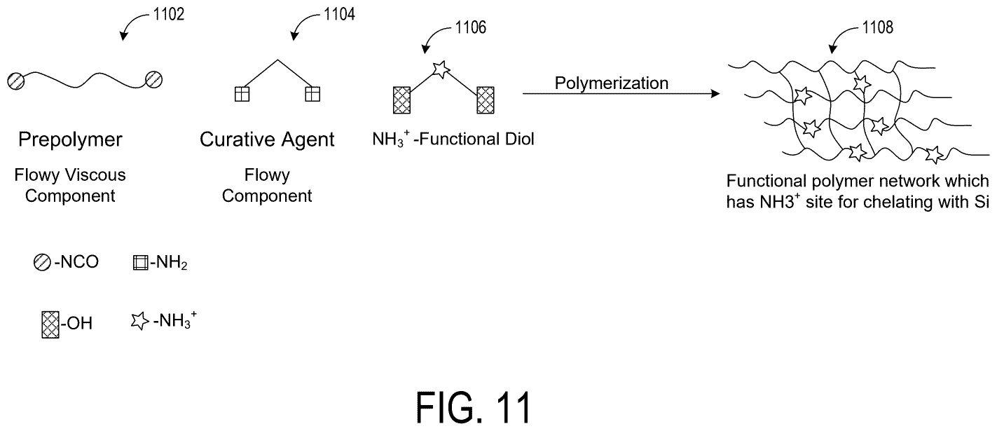

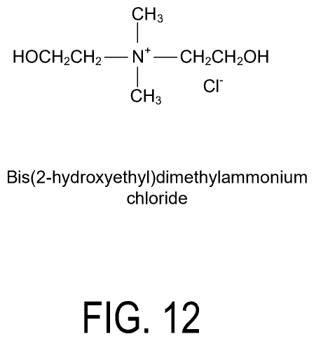

In other examples, molecules with quaternary ammonium functional groups can be covalently bonded to a polymer planarization pad. Bonding such molecules covalently in the polymer network of a polymer planarization pad can allow polysilicon to be planarized as described above. FIG. 11 shows an example incorporation of a functional molecule comprising a quaternary ammonium functional group into a polymer planarization pad by covalent bonding. In FIG. 11, a prepolymer 1102 with isocyanate end groups, a curative agent 1104 with amine end groups, and a functional molecule 1106 comprising a quaternary ammonium functional group and also comprising suitable functional end groups (hydroxyl groups in this example) to react with the prepolymer are mixed. After mixing, the mixture is molded and cured as described above. The resulting polymer 1108 has at least some of the functional molecule with the quaternary ammonium groups incorporated into the polymer chains that form the polymer network of the planarization pad, rather than dispersed within a polymer network. An example functional molecule is bis(2-hydroxyethyl)dimethyl ammonium chloride, a structure of which is shown in FIG. 12. In other examples, any other suitable functional molecule comprising an quaternary ammonium group can be used.

In the examples of FIGS. 6-12, small functional molecules are covalently bonded on a polymer network of a polymer planarization pad. In other examples, functional polymers can be covalently bonded on the polymeric network. Functional polymer (e.g., the above-described polyelectrolytes) can provide multiple chelating sites for interacting with silicon of a polysilicon surface. This may help to provide for relatively high material removal rates during polysilicon planarization, as it may provide for a relatively higher density of chelating sites than the use of small functional molecules. In such examples, as described above for small functional molecules, an amine or hydroxyl terminated functional polymer may be used to covalently bond the functional polymer with an isocyanate prepolymer to form a polyurea and/or polyurethane linkage. Both ends of the functional polymer can be reactive to prepolymer, while functional sites such as a quaternary ammonium group remain available for polysilicon planarization.

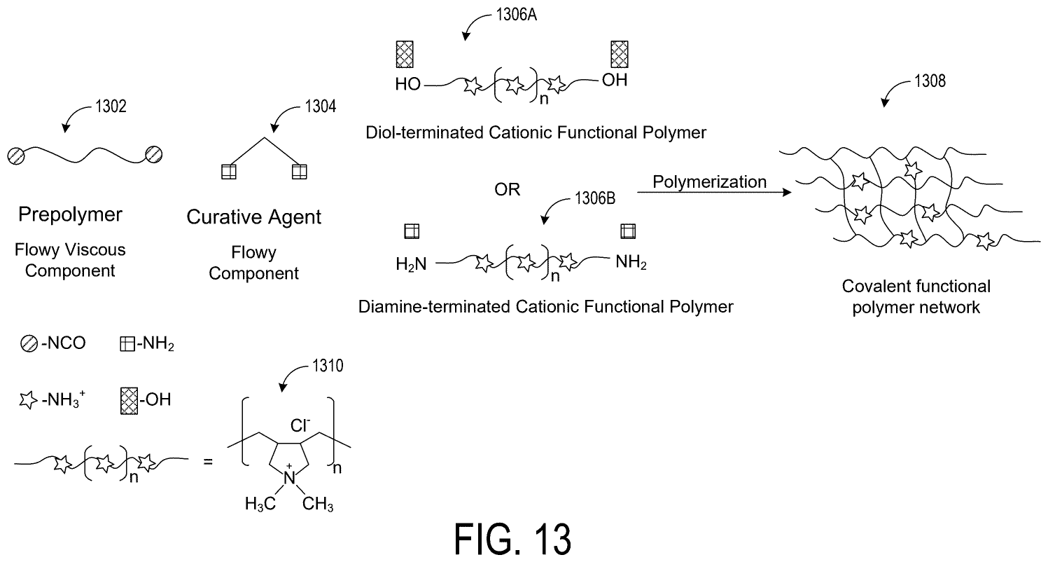

FIG. 13 shows an example incorporation of a diol-terminated cationic functional polymer comprising free amine groups, and alternatively or additionally a diamine-terminated cationic functional polymer. Here, a prepolymer 1302 with isocyanate end groups, a curative agent 1304 with amine end groups, and one or more of a diol-terminated cationic functional polymer 1306A or an amine-terminated cationic functional polymer 1306B are mixed. After mixing, the mixture is molded and cured as described above. The resulting polymer 1208 has at least some of the diol-terminated cationic functional polymer and/or the amine-terminated cationic functional polymer covalently bonded to the polymer chains that form the polymer network of the planarization pad, rather than dispersed within the polymer network. An example functional cationic functional polymer is poly(diallyldimethylammonium chloride), a structure of which is shown in FIG. 1310. In other examples, any other suitable cationic functional polymer comprising a free amine or a free amine group can be used.

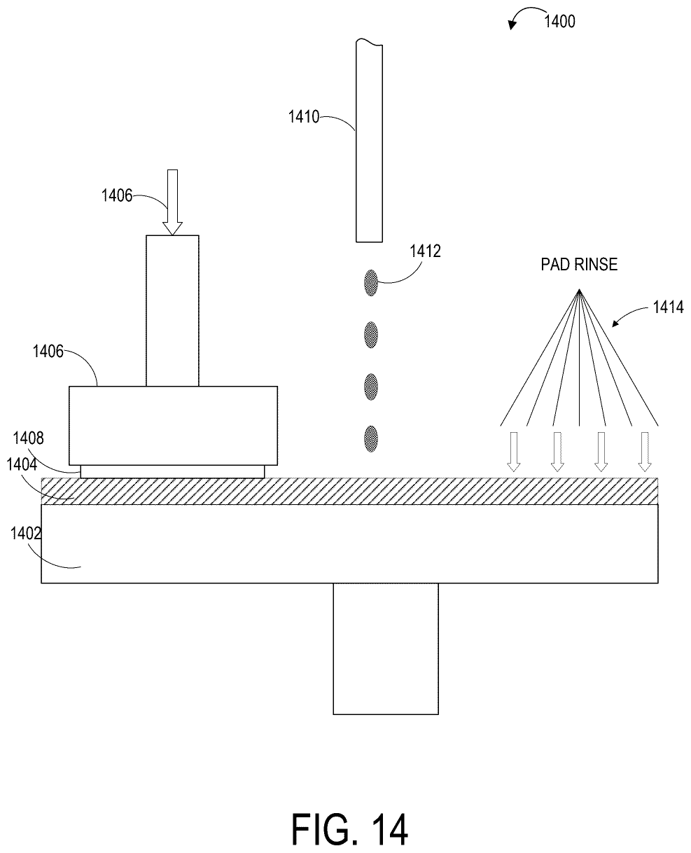

FIG. 14 shows a schematic depiction of an example abrasive-free planarization system 1400 suitable for use with the example functionalized planarization pads configured for polysilicon planarization disclosed herein. System 1400 comprises a platen 1402 that supports a functionalized pad 1404 as disclosed. The system 1400 further includes a substrate holder 1406 configured to hold a substrate 1408 against the surface of the functionalized pad 1404, and a planarization solution introduction system 1410 for introducing a planarization solution 1412 onto the functionalized pad 1404. The system 1400 further may comprise a pad rinsing system 1414 configured to rinse possible contaminant materials from the functionalized pad 1404, such as complexed materials that have been removed from the surface of the substrate 1408. Pad rinsing system 1414 also may be used to clean the pad between using different planarization solution chemistries, as described below. Other components (not shown) that may be incorporated into system 1400 include, but are not limited to, a spent solution recovery system, a materials recirculation system (e.g. for recirculating the planarization solution in a closed loop process), and a species stripping system.

In conventional CMP processes, the substrate holder pushes the substrate against a planarization pad supported on a platen, and the pad and the substrate are rotated relative to one another in a non-concentric pattern. In such conventional processes, relatively high rates of rotations are used, such as between 40-100 rpm. Further, the substrate is pushed against the pad with a relatively high pressure, such as in a range of 1-4 pound per square inch. In contrast, a lighter pressure can be used in the disclosed examples, including but not limited to pressures in the range of 0.25 to 0.75 pounds per square inch. The lighter pressure may avoid distortion of the pad shape, and may reduce shear stresses compared to conventional CMP processes. Likewise, a slower rate of rotation may be used in the disclosed examples than with conventional CMP processes, as the rotational motion is not used for abrasion. Instead, rotation of the platen 102 helps to distribute planarization fluid across the pad 104. Any suitable rate of rotation may be used. Examples include rates in a range of 0-100 rpm. More specific examples include rates of 5-60 rpm. As mentioned above, the rate of rotation may be lower than a rate at which a platen rotates in a conventional CMP process, as the rotational motion is not being used in the examples herein to abrade material from a substrate. It will be understood that many different configurations and designs are possible for a variety of platform types (rotary, linear or belt style, vertically, rollers, hollow fibers).

The planarization solution may comprise chemical components to hydrolyze a substrate material (e.g. by oxidation and dissolution) together with the functionalized pad 1404. As mentioned above, polysilicon may be removed via a planarization solution comprising poly(diallyldimethylammonium chloride) (PDADMAC) in deionized water. In some such examples, the PDADMAC solution may be mixed with oxalic acid and/or hydrogen peroxide, and further may comprise a suitable acid or alkaline agent (e.g. nitric acid or potassium hydroxide) to adjust the pH to a basic level. Other reagents also may be used to planarize polysilicon, including but not limited to poly(2-acrylamido-2-methyl-1-propanesulfonic acid) (polyAMPS), poly(dimethylamine-co-epichlorohydrin-co-ethylenediamine), poly(allylamine), and poly(ethylene imine) (PEI).

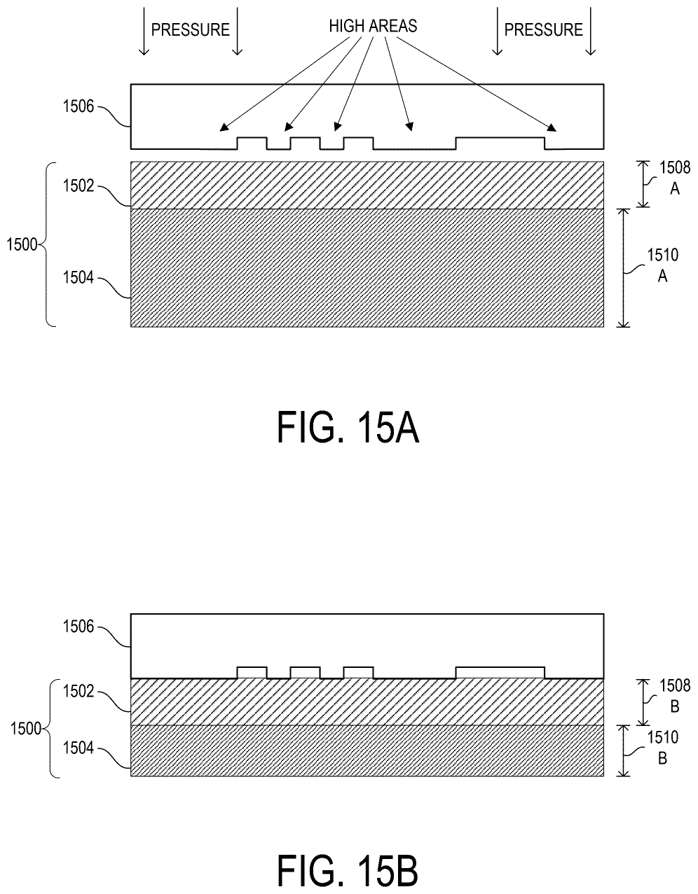

FIGS. 15A-15B show a schematic view of an example pad 1500 that is suitable for use as a functionalized pad for polysilicon planarization as disclosed. The pad 1500 includes a first polymer layer 1502 and a second polymer layer 1504. The first polymer layer 1502 is configured to contact substrate 1506 during abrasive-free chemical planarization. The second polymer layer 1504 is positioned on an opposite side of the first polymer layer 1502 as a substrate-contacting side of the first polymer layer 1502. Such a dual layer structure may be used to implement polysilicon planarization as disclosed, wherein one or both of the first polymer layer 1502 or the second polymer layer 1504 can be functionalized for polysilicon planarization according to the examples disclosed herein. Further, the first polymer layer 1502 and the second polymer layer 1504 can be configured to have other functionalities. For example, the second polymer layer can be configured to be compressible. As such, when the first polymer layer 1502 is brought into contact with substrate 1506 during a chemical planarization process, the second polymer layer 1504 can compress to avoid applying unwanted pressure against the substrate 1506. Further, the first polymer layer can comprise a textured surface in some examples, as described in more detail below.

The first polymer layer 1502 and the second polymer layer 1504 may be joined together in any suitable manner. In some examples, the first polymer layer 1502 and the second polymer layer 1504 are joined by an adhesive. In other examples, one of the first polymer layer 1502 or second polymer layer 1504 is insert molded into the other of the first polymer layer 1502 or the second layer. In yet other examples, one or both of the first polymer layer 1502 or the second polymer layer 1504 can be additively manufactured. In yet further examples, the first polymer layer 1502 and the second polymer layer 1504 can be formed in a same molding or casting process, but wherein the composition of the material being molded or cast is changed mid-pour or mid-injection. In such examples, by virtue of having dissimilar characteristics between the top layer and the bottom layer, this constitutes an asymmetric medium. Such an asymmetric medium may, in some examples, include a gradual and systematic variation in characteristics, or may transition abruptly at the interface of two layers. This enables control over compressibility and other mechanical characteristics of the first polymer layer 1502 and/or the second polymer layer 1504. In other examples, the two layers will be integrated and seemingly compose a composite pad. Furthermore, the pad 1500 may be adhered or otherwise joined to an additional sub-layer, such as a woven textile matrix or soft polymer sheet (e.g. sub-pads of the type currently used for conventional CMP pads).

In some examples, polymer phase inversion or phase separation may be used to form such an asymmetric structure. In other examples, vapor induced phase separation (air casting) may be used. As yet another example, liquid induced phase separation (immersion casting) may be used by dissolving polymer in solvent at room temperature and immersing in liquid non-solvent to induce phase separation. This enables different morphologies including asymmetric membranes. Methods for forming an asymmetrical structure (e.g. a multi-layer porous matrix) include manipulating phase separation conditions during single layer casting, casting a small pore size membrane on a large pore size substrate, casting multi-layers of different pore sizes contemporaneously, laminating different pore size layers together, and utilizing temperature induced phase separation (TIPS or melt casting) (in which a polymer is heated above melting point and dissolved in porogens, and phase separation induced by cooling).

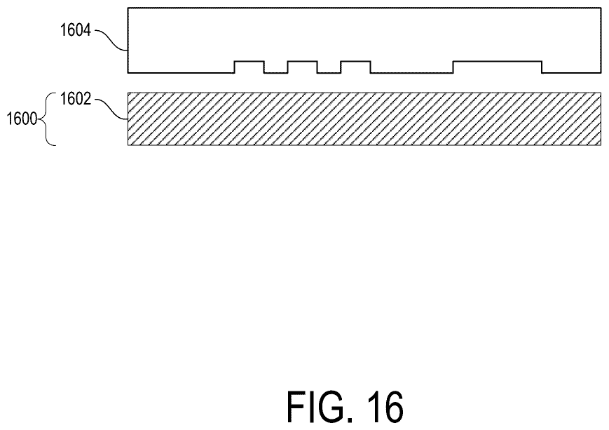

In other examples, the pad comprises a single polymer layer. FIG. 16 shows a schematic view of another example planarization pad 1600 that is functionalized for polysilicon planarization according to the disclosed examples. The pad 1600 comprises a single polymer layer 1602 configured to contact substrate 1606. In yet other examples, a pad comprises three or more layers.

Referring again to FIGS. 15A-15B, in some examples, the first polymer layer 1502 may be relatively thin compared to the second pad. The first polymer layer 1502 may comprise relatively larger pores, may be hydrophilic, and is functionalized as disclosed to planarize polysilicon. In some such examples, the first layer may have a thickness in a range of 0.1 micron to five microns thick. In other examples, the first layer can have any other suitable thickness (e.g., a thickness of less than 0.1 microns or greater than five microns). In yet other examples, the first polymer layer 1502 can be nonporous. For example, and as described in more detail below, the first polymer layer may comprise a textured surface that provides additional surface area for the abrasive-free planarization chemistry.

In some examples, the second polymer layer 1504 may be relatively thicker than the first layer, and may have relatively smaller pores than the first layer. In some examples, the second layer may be configured to retain materials removed by the first layer. For example, the second layer may comprise a surface that is chemically modified with complexing agents adsorbed or bonded to the second layer within the pores to retain material, such as silicon, removed from the substrate. In some examples, the second layer may have a thickness of several microns to 3 mm thick, and in more specific examples, from 40 microns to 2 mm thick.

FIGS. 15A-15B also depict contact between a substrate 1506 and the pad 1500. As shown in FIGS. 15A-15B, topologically higher regions of the substrate 1506 contact the pad 1500, and the pad 1500 does not contact topologically lower regions of the substrate. The use of relatively little pressure of the substrate 1506 against the pad 1500, combined with the planarization chemistry being located within the pad 1500 instead of in the space between the pad and substrate, helps to achieve removal of polysilicon from the topologically higher regions of the substrate 1506 at a higher rate compared to, or even to the exclusion of, the topologically lower regions, as the topologically higher regions are in contact with the hydrolyzing and/or complexing environment in the pad.

In FIGS. 15A-15B, pressure is applied via the substrate 1506 that presses the substrate 1506 against the pad 1500. In some examples, the pad 1500 is compressed merely by a weight of the substrate 1506. In other examples, additional force is applied to the substrate 1506 (e.g., via the substrate holder 106 of FIG. 1) to press the substrate 1506 against the pad 1500. Such force(s) can cause compression of the pad 1500 as shown in FIG. 15B. In some examples, as introduced above, the second polymer layer 1504 is configured to provide compressibility while the first polymer layer 1502 can have a porous and/or textured surface configured to remove material during the abrasive-free chemical planarization process.

Further, the first and/or second layer may be designed with mechanical attributes such that it is rigid enough to handle the wafer load and the down force/applied pressures. In some examples, the first polymer layer and/or a second polymer layer may have a storage modulus of 15 MPa to 1200 MPa. More specific examples include storage moduli of 400-800 MPa. In some examples, the first polymer layer and/or the second polymer layer have a loss modulus of 100-600 MPa. More specific examples include loss moduli of 150-500 MPa. In some examples, the first polymer layer and/or a second polymer layer have a Tan delta (loss divided by storage) of 0.2-0.9. More specific examples include 0.4-0.8. In some examples, the first polymer layer and/or a second polymer layer have a compressibility of <5%, and/or a surface tension of less than 40 mN/m. The viscoelastic characteristics and physical attributes of the first polymer layer and/or the second polymer layer can be determined by standard dynamic mechanical analysis (DMA), differential scanning calorimetry (DSC) and thermogravimetric analysis (TGA) methods, as examples.

In some examples, as mentioned above, the second polymer layer 1504 is more compressible than the first polymer layer 1502. The first layer polymer 1502 has a thickness 1508A in FIG. 15A before compression. The first polymer layer 1502 has a second thickness 1508B after compression that is substantially the same as the first thickness 1508A. In contrast, the second polymer layer 1504 has a first thickness 1510A before compression. The second polymer layer 1504 has a second thickness 1510B in FIG. 15B that is less than the first thickness 1510A of FIG. 15A. In this manner, the second polymer layer 1504 may absorb compressive force while the first polymer layer 1502 maintains a planar substrate-facing surface. In other examples, the first polymer layer 1502 is more compressible than the second polymer layer 1504. In this manner, the second polymer layer 1504 can serve as a relatively firm “bed” that supports the first polymer layer 1502 against the substrate 1506.

As mentioned above, the first layer and/or the second layer can be formed to be porous. In some examples, pores are formed in the first layer and/or the second layer utilizing TIPS or melt casting. Other techniques to form pores within the polymer include introducing a blowing agent such as steam and/or other gases (e.g., air, carbon dioxide, or nitrogen) to form bubbles in the molten polymer before it solidifies.

In some more specific examples, the first polymer layer 1502 has a smaller pore fraction than the second polymer layer 1504. For example, the first layer may have an average pore size in a range of 1 nm to 1000 nm, preferably 30 nm to 200 nm. The second layer may also have an average pore size in a range of 5 nm to 1000 nm, preferably 200 nm to 1000 nm. In such examples, the second polymer layer 1504 can provide suitable compressibility to accommodate deformation of the first polymer layer 1502. In other examples, the first polymer layer 1502 has a greater pore fraction than the second polymer layer 1504. In yet other examples, one or more of the first polymer layer 1502 and/or the second polymer layer 1504 is nonporous.

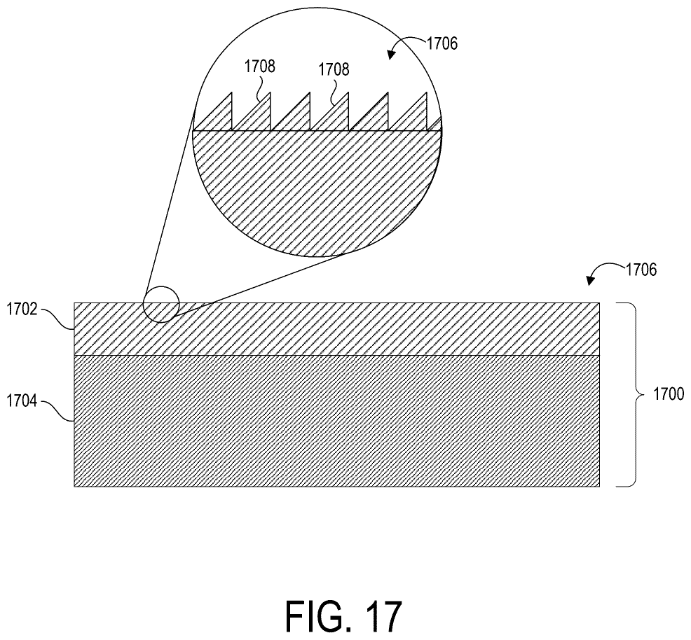

In some examples, the first layer comprises a textured substrate-facing surface. FIG. 17 shows a schematic view of another example pad 1700 that is suitable for use as the example functionalized pads disclosed herein. The pad 1700 includes a first polymer layer 1702 and a second polymer layer 1704. The first polymer layer 1702 comprises a textured substrate-facing surface 1706 configured to contact a substrate during abrasive-free chemical planarization. The textured substrate-facing surface 1706 comprises a plurality of structures 1708, such as bumps, ridges, or grooves, that can cause friction between the pad 1700 and the substrate, which can lead to the removal of material from the substrate. Structures 1708 can be formed when molding a pad, as described above for incorporating polysilicon removal functionality into the pad. In addition, the textured surface can compensate for a lack of porosity by providing surface area for chemical reactions and/or channels that conduct planarization fluid during processing.

### Experimental Results

Based on schemes described above, functionalized polymeric pads of various characteristics for the application of polishing of poly-Si wafers were prepared. The initial batch of pads were 9-inch for lab scale polishing experiments of 4×4 cm² sized poly-Si coupons. For various application, it is desired to have controllable materials removal rate. Certain application demands low removal, while others aim for higher removal rates. In this regards, various pads have been prepared. Following is the representative class of the functional pads for controllable removal rates of polysilicon materials during CMP process. As described above, polysilicon is a network of material with silicon-silicon chemical bonds. For polysilicon removal, silicon-silicon chemical bonds are required to rupture. In this regard, various functionality combined with different pad hardness played a role in a synergetic effect to realize controllable removal rates. Table 1 below shows classes of pads of various polymeric properties.

TABLE 1
Functional pads for the polishing application of polysilicon.

| | | Pad | | | |
|---|---|---|---|---|---|
| Pad | Pad | Hardness | Pad | | |
| no. | Designation | (D) | Functionality | Pad Description | Note |
| Poly- | COOH | 64 ± 2 | Carboxylic | Hard pad with | Functional groups in |
| Si-1 | | | | poly-urethane- | various pads are for |
| | | | | polyurea | collaboration in |
| | | | | linkage with | efficient distribution |
| | | | | availability of | of polishing |
| | | | | carboxylic | solutions during |
| | | | | functionality | ongoing polishing |
| Poly- | COOH—SO₃H—QN⁺ | 39 ± 2 | Carboxylic- | Soft pad with | and participation in |
| Si-2 | | | sulfonic- | poly-urethane- | poly-Si polishing |
| | | | quaternary | polyurea | mechanism |
| | | | ammonium | linkage with | |
| | | | | availability of | |
| | | | | carboxylic plus | |
| | | | | sulfonic plus | |
| | | | | quaternary | |
| | | | | ammonium | |
| | | | | functionality | |
| Poly- | COOH—QN⁺ | 40 ± 3 | Carboxylic- | Soft pad with | |
| Si-3 | | | quaternary | poly-urethane- | |
| | | | ammonium | polyurea | |
| | | | | linkage with | |
| | | | | availability of | |
| | | | | carboxylic plus | |
| | | | | quaternary | |
| | | | | ammonium | |
| | | | | functionality | |
| Poly- | QNT | 30 ± 2 | Quaternary | Softer pad with | |
| Si-4 | | | ammonium | poly-urethane- | |
| | | | group | polyurea | |
| | | | | linkage with | |
| | | | | availability of | |
| | | | | quaternary | |
| | | | | ammonium | |
| | | | | functionality | |
| Poly- | COOH—PDADMAC | 59 ± 3 | Carboxylic- | hard pad with | |
| Si-5 | (P—QN⁺) | | poly(quaternary | poly-urethane- | |
| | | | ammonium) | polyurea | |
| | | | | linkage with | |
| | | | | availability of | |
| | | | | polymeric | |
| | | | | quaternary | |
| | | | | ammonium | |
| | | | | functionality | |

In a first case, a hard pad with covalently-linked carboxylic functionality was developed for the polysilicon polishing. Support of pad hardness (64D) by downforce during CMP process initiate rupturing silicon-silicon bond by the solution composition the alkaline pH regime. Three different additive formulations for planarization solutions were tested, and achieved relatively higher removal rate of poly-Si as shown in Table 2.

TABLE 2
Polishing outcome of the polysilicon by varied solution additives
on pad type-1 (poly-Si-1 pad with carboxylic functionality).

| | | Poly-Si | |
|---|---|---|---|
| Functional | Polishing | MRR | |
| Pad | Additive | (nm/min) | Note |
| Poly- | PolyDADMAC | 326 ± 21 | First step is to remove |
| Si-1 | (500 ppm) | | native oxide layer |
| | PEI | 246 ± 17 | Second step is to polish |
| | (500 ppm) | | |
| | PDADMAC | 314 ± 23 | polysilicon coupons with |
| | (250 ppm) + | | functional pad |
| | PEI | | |
| | (250 ppm) | | |

Primary polishing parameters: Lab scale polisher, coupon size: 4 × 4 cm², flow rate: 120 ml/min, polishing pressure: 4 psi, pH-10, polishing time: 45 sec
Primary pad parameters: Pad hardness: 64 ± 2, pad dimeter: 9″, grooving: concentric

In another case, a soft pad with multi-functionality was developed for polysilicon polishing. The pad showed a controlled synergy effect where the softness of the pad (low hardness value of 39D) demonstrated relatively lower removal rate of poly-Si in combination with functionality of the pad (covalently-linked sulfonic plus carboxylic plus quaternary ammonium). Three different additive formulations were tested, and achieved relatively lower removal rate of poly-Si as shown in Table 3.

TABLE 3
Polishing outcome of the polysilicon by varied polishing
additives on pad type-2 (poly-Si-2 pad with carboxylic
plus sulfonic plus quaternary ammonium functionality).

| | | Poly-Si | |
|---|---|---|---|
| Functional | Polishing | MRR | |
| Pad | Additive | (nm/min) | Note |
| Poly- | PolyDADMAC | 74 ± 9 | First step is to remove |
| Si-2 | (500 ppm) | | native oxide layer |
| Pad | PEI | 53 ± 11 | Second step is to polish |
| | (500 ppm) | | |
| | PDADMAC | 81 ± 17 | polysilicon coupons with |
| | (250 ppm) + | | functional pad |
| | PEI | | |
| | (250 ppm) | | |

Primary polishing parameters: Lab scale polisher, coupon size: 4 × 4 cm², flow rate: 120 ml/min, polishing pressure: 4 psi, pH-10, polishing time: 45 sec
Primary pad parameters: Pad hardness: 39 ± 2, pad dimeter: 9″, grooving: concentric

In another case, a soft pad with dual-functionality was developed for the polysilicon polishing. The pad showed a controlled synergy effect where a softness of the pad (low hardness value of 40D) demonstrated a lower removal rate of polysilicon in combination with functionality of the pad (covalently-linked carboxylic plus quaternary ammonium). Three different additive formulations were tested, and achieved lower removal rate of polysilicon as shown in Table 4.

TABLE 4
Polishing outcome of the poly-Si by varied polishing
additives on pad type-3 (poly-Si-3 pad with carboxylic
plus quaternary ammonium functionality).

| | | Poly-Si | |
|---|---|---|---|
| Functional | Polishing | MRR | |
| Pad | Additive | (nm/min) | Note |
| Poly- | PolyDADMAC | 28 ± 8 | First step is to remove |
| Si-3 | (500 ppm) | | native oxide layer |
| Pad | PEI | 32 ± 12 | Second step is to polish |
| | (500 ppm) | | |
| | PDADMAC | 37 ± 9 | polysilicon coupons with |
| | (250 ppm) + | | functional pad |
| | PEI | | |
| | (250 ppm) | | |

Primary polishing parameters: Lab scale polisher, coupon size: 4 × 4 cm², flow rate: 120 ml/min, polishing pressure: 4 psi, pH-10, polishing time: 45 sec
Primary pad parameters: Pad hardness: 40 ± 3, pad dimeter: 9″, grooving: concentric

In another case, a softer pad with quaternary ammonium functionality was developed for polysilicon polishing. The pad showed a controlled synergy effect where softness of the pad (lower hardness value of 30D) demonstrated lower removal rate of polysilicon in combination with functionality of the pad (covalently-linked quaternary ammonium). Three different additive formulations were tested to achieve a very low removal rate of poly-Si as shown in Table 5. As certain application focuses on low removal of polysilicon, this functional pad type at lower hardness (30D) is a potential candidate.

TABLE 5
Polishing outcome of the poly-Si by varied polishing additives on
pad type-4 (poly-Si-4 pad with quaternary ammonium functionality).

| | | Poly-Si | |
|---|---|---|---|
| Functional | Polishing | MRR | |
| Pad | Additive | (nm/min) | Note |
| Poly- | PolyDADMAC | 20 ± 6 | First step is to remove |
| Si-4 | (500 ppm) | | native oxide layer |
| Pad | PEI | 18 ± 11 | Second step is to polish |
| | (500 ppm) | | |
| | PDADMAC | 26 ± 9 | poly-Si coupons with |
| | (250 ppm) + | | functional pad |
| | PEI | | |
| | (250 ppm) | | |

Primary polishing parameters: Lab scale polisher, coupon size: 4 × 4 cm², flow rate: 120 ml/min, polishing pressure: 4 psi, pH-10, polishing time: 45 sec
Primary pad parameters: Pad hardness: 30 ± 2, pad dimeter: 9″, grooving: concentric

In another case, a hard pad with a polymeric chain of quaternary ammonium functionality has been developed for the poly-Si polishing. Poly(diallyl dimethyl ammonium chloride) (PDADMAC) functionalized polymeric pad (dispersed, rather than covalently-linked) was by utilizing varied solution components to achieve high removal rates of poly-Si. Three different additive formulations were tested to achieve very high removal rate of poly-Si as shown in Table 6. This pad type suggests for the significant improvement in high MRR for poly-Si.

TABLE 6
Polishing outcome of the poly-Si by varied polishing additives
on pad type-5 (poly-Si-5 pad with carboxylic plus sulfonic
plus poly(quaternary ammonium) functionality).

| | | Poly-Si | |
|---|---|---|---|
| Functional | Polishing | MRR | |
| Pad | Additive | (nm/min) | Note |
| Poly- | PolyDADMAC | 341 ± 32 | First step is to remove |
| Si-5 | (500 ppm) | | native oxide layer |
| Pad | PEI | 267 ± 24 | Second step is to polishing |
| | (500 ppm) | | |
| | PDADMAC | 318 ± 19 | poly-Si coupons with |
| | (250 ppm) + | | functional pad |
| | PEI | | |
| | (250 ppm) | | |

Primary polishing parameters: Lab scale polisher, coupon size: 4 × 4 cm², flow rate: 120 ml/min, polishing pressure: 4 psi, pH-10, polishing time: 45 sec
Primary pad parameters: Pad hardness: 59 ± 3, pad dimeter: 9″, grooving: concentric

### Parameter Changes in Solution Composition

Various parameters have been tuned by using one polymeric pad (Poly-Si-1 pad of Table 2) for poly-Si polishing applications. The tuning in the materials removal rates has been observed as shown below.

### (A) Varied PDADMAC Concentration in Planarization Solution

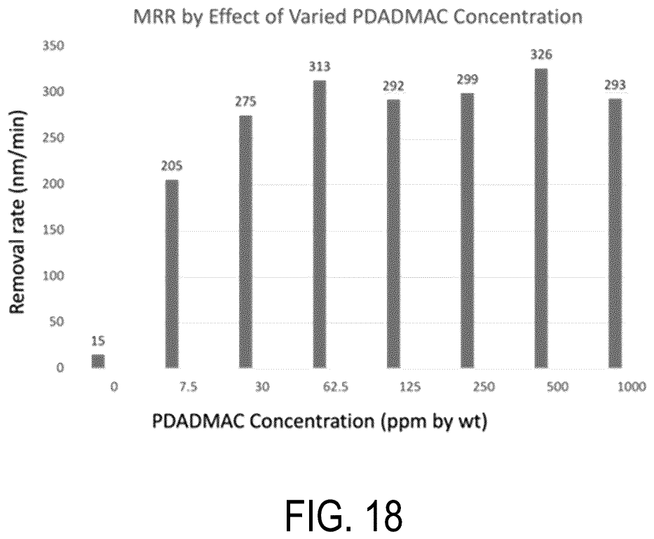

In a first case, different concentrations of PDADMAC (in ppm) in the planarization solution were used during CMP process of poly-Si coupons on carboxylic pad at 4 psi downforce and at pH-10, with KOH as a pH adjuster, and a 120 ml/min flow rate. Below in FIG. 18, the average MRR of poly-Si is shown.

(B) pH Effect in poly-Si Planarization

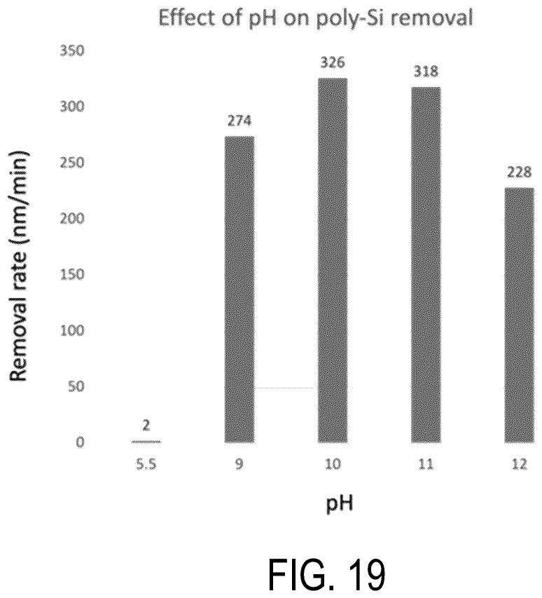

In another case, different pH of polishing solution has been varied and observed MRR was tunable as shown in FIG. 19. Here, the pad was Poly-Si-1. The planarization solution composition was 500 ppm PDADMAC at varied pH, KOH as a pH adjuster, using 4 psi down pressure and 120 ml/min solution flow rate.

### (C) pH Adjuster Effect in Poly-Si Planarization

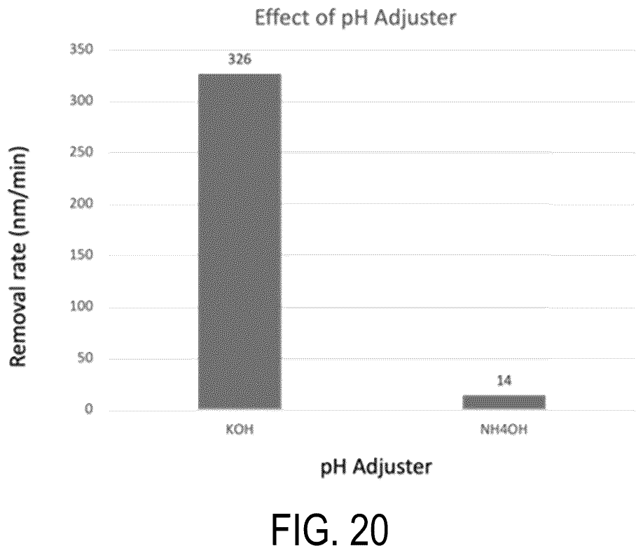

In another case, different pH adjusters were used to achieve pH 10 of polishing solution and observed MRR was very different for the different pH adjusters, as shown in FIG. 20. Again, here the pad was Poly-Si-1. The solution composition was 500 ppm PDADMAC at pH-10, varied pH adjuster, using 4 psi down pressure and 120 ml/min solution flow rate.

### (D) Varied Down Pressure During Poly-Si Planarization

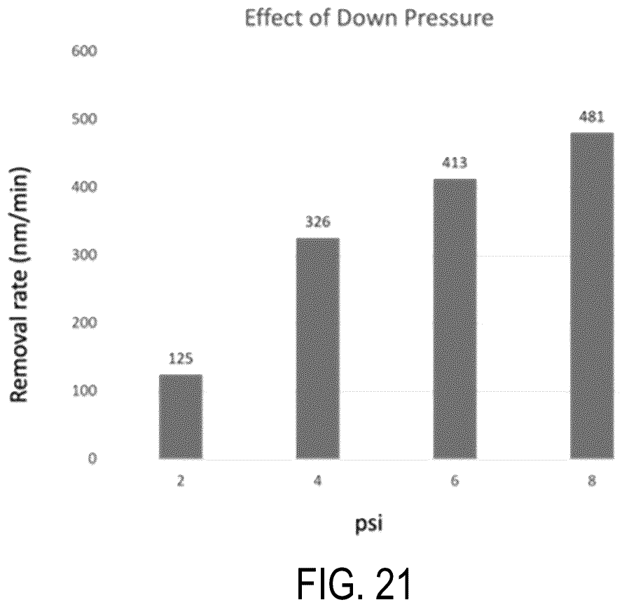

In another case, a down pressure of the coupon carrier to pad interface was varied, and tunable MRR was observed as shown in FIG. 21. Here, the pad again was Poly-Si-1. The solution composition was 500 ppm PDADMAC at a pH of 10, using KOH as a pH adjuster, varied down pressure, and a 120 ml/min planarization solution flow rate.

### (E) Varied Flow Rate of Dispensing Polishing Solution During CMP Process of Poly-Si

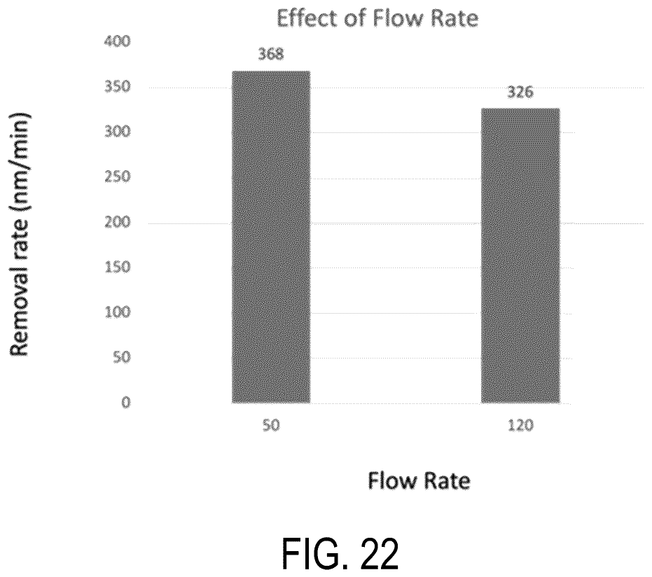

In another case, two different flow rates were applied in separate experiments by keeping all other polishing parameter constant to observe the tunability of MRR of poly-Si, as shown in FIG. 22.

In another case, two different flow rates were applied in separate experiments by keeping all other polishing parameter constant to observe the tunability of MRR of poly-Si, as shown in FIG. 22. Here again, the pad was Poly-Si-1. The solution composition was 500 ppm PDADMAC at a pH of 10, KOH as a pH adjuster, with varied down pressure, and varied solution flow rate. During the planarization, solution flow was introduced directly on the top surface of the pad at the center region, which spread out to wafer surface while rotation).

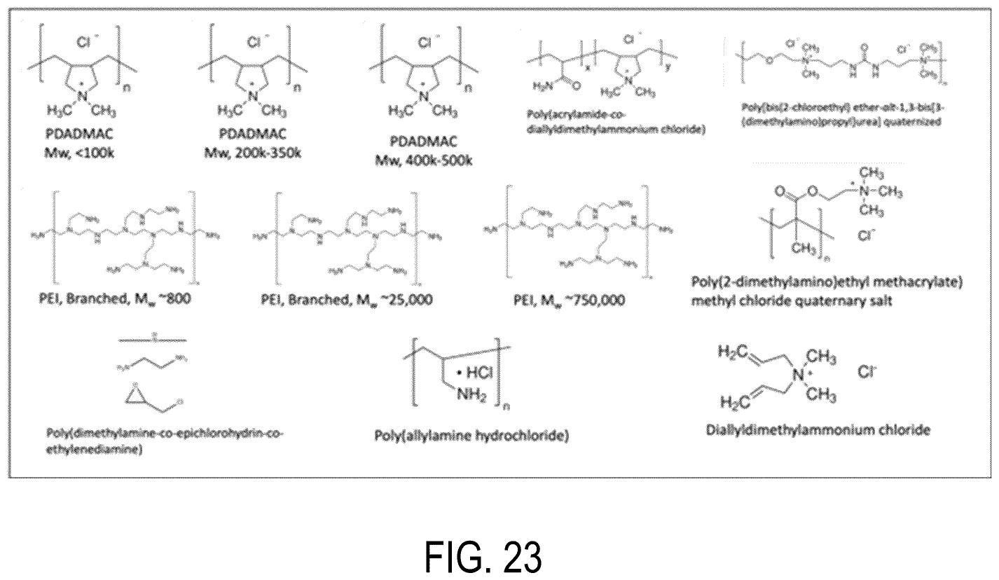

Thus, adjusting such tuning parameters as those described herein may help to achieve a wider MRR spectrum from lower nm/min to higher nm/min range (10-1000 nm/min), and beyond. The compounds shown in FIG. 23 are promising candidates molecules for use in a planarization solution when using a functionalized pad according to the present disclosure, and/or for functionalizing a pad as disclosed.

This disclosure is presented by way of example and with reference to the associated drawing figures. Components, process steps, and other elements that can be substantially the same in one or more of the figures are identified coordinately and are described with minimal repetition. It will be noted, however, that elements identified coordinately can also differ to some degree. It will be further noted that some figures can be schematic and not drawn to scale. The various drawing scales, aspect ratios, and numbers of components shown in the figures can be purposely distorted to make certain features or relationships easier to see.

“And/or” as used herein is defined as the inclusive or V, as specified by the following truth table:

| A | B | A ∨ B |
|---|---|---|
| True | True | True |
| True | False | True |
| False | True | True |
| False | False | False |

The terminology “one or more of A or B” as used herein comprises A, B, or a combination of A and B. The terminology “one or more of A, B, or C” is equivalent to A, B, and/or C. As such, “one or more of A, B, or C” as used herein comprises A individually, B individually, C individually, a combination of A and B, a combination of A and C, a combination of B and C, or a combination of A, B and C.

It will be understood that the configurations and/or approaches described herein are example in nature, and that these specific embodiments or examples are not to be considered in a limiting sense, because numerous variations are possible. The specific routines or methods described herein can represent one or more of any number of strategies. As such, various acts illustrated and/or described can be performed in the sequence illustrated and/or described, in other sequences, in parallel, or omitted. Likewise, the order of the above-described processes can be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A pad for performing abrasive-free chemical planarization of a polycrystalline silicon (polysilicon) surface, the pad comprising:
a polymer layer incorporating a functional group reactive with polysilicon to remove silicon from the polysilicon surface.

2. The pad of claim 1, wherein the functional group is a free amine group, a quaternary ammonium group, or a —N═ group.

3. The pad of claim 1, wherein the functional group reactive with polysilicon is incorporated into the pad as a small functional molecule dispersed within a polymer network of the pad.

4. The pad of claim 3, wherein the small functional molecule comprises one or more of methyltrioctylammonium chloride (MTAC), cetyltrimethylammonium Bromide (CTAB), dodecyltrimethylammonium bromide (DTAB), (2-Chloroethyl)trimethylammonium chloride (CTAC), glycidyltrimethylammonium chloride (GTAC), and Girard's Reagent T.

5. The pad of claim 1, wherein the functional group reactive with polysilicon is incorporated into the pad as a polyelectrolyte dispersed within a polymer network of the pad.

6. The pad of claim 5, wherein the polyelectrolyte dispersed within a polymer network of the pad comprises one or more of poly(diallyldimethylammonium chloride), poly(acrylamide-co-diallyl dimethylammonium chloride, poly(2-dimethylamino)ethyl methacrylate) methyl chloride, poly(dimethylamine-co-epichlorohydrin-co-ethylenediamine), and poly(allylamine hydrochloride).

7. The pad of claim 1, wherein the functional group reactive with the polysilicon is incorporated into the pad as a small molecule that is covalently bonded with a polymer network of the pad.

8. The pad of claim 7, wherein the small molecule comprises 2,6-pyridinedimethanol.

9. The pad of claim 1, wherein the pad comprises a polyurea-polyurethane copolymer.

10. The pad of claim 1, wherein the functional group reactive with the polysilicon is incorporated in the pad as a polyelectrolyte covalently bonded with a polymer network of the pad.

11. The pad of claim 1, wherein the polyelectrolyte comprises poly(diallyldimethylammonium chloride).

12. A chemical planarization tool, comprising
a pad for performing abrasive-free chemical planarization of polycrystalline silicon, the pad comprising a polymer layer incorporating a functional group reactive with polysilicon to remove silicon from the polysilicon surface;
a platen supporting the pad;
a substrate holder configured to hold a substrate against the surface of the pad; and
a planarization solution introduction system for introducing a planarization solution onto the pad.

13. The chemical planarization tool of claim 12, wherein the functional group is a free amine group, a quaternary ammonium group, or a —N═ group.

14. The chemical planarization tool of claim 12, wherein the functional group reactive with polysilicon is incorporated into the pad as a small functional molecule dispersed within a polymer network of the pad.

15. The chemical planarization tool of claim 12, wherein the small functional molecule comprises one or more of methyltrioctylammonium chloride (MTAC), cetyltrimethylammonium Bromide (CTAB), dodecyltrimethylammonium bromide (DTAB), (2-Chloroethyl)trimethylammonium chloride (CTAC), glycidyltrimethylammonium chloride (GTAC), or Girard's Reagent T.

16. The chemical planarization tool of claim 12, wherein the functional group reactive with polysilicon is incorporated into the pad as a polyelectrolyte dispersed within a polymer network of the pad.

17. The chemical planarization tool of claim 16, wherein the polyelectrolyte dispersed within a polymer network of the pad comprises one or more of poly(diallyldimethylammonium chloride), poly(acrylamide-co-diallyl dimethylammonium chloride, poly(2-dimethylamino)ethyl methacrylate) methyl chloride, poly(dimethylamine-co-epichlorohydrin-co-ethylenediamine), or poly(allylamine hydrochloride).

18. The chemical planarization tool of claim 12, wherein the functional group reactive with the polysilicon is incorporated into the pad as a small molecule that is covalently bonded with a polymer network of the pad.

19. The chemical planarization tool of claim 18, wherein the small molecule comprises 2,6-pyridinedimethanol.

20. The chemical planarization tool of claim 12, wherein the pad comprises a polyurea-polyurethane copolymer.

21. The chemical planarization tool of claim 12, wherein the functional group reactive with the polysilicon is incorporated in the pad as a polyelectrolyte covalently bonded with a polymer network of the pad.

22. The chemical planarization tool of claim 12, wherein the polyelectrolyte comprises poly(diallyldimethylammonium chloride).
